(19) United States
(12) Patent Application Publication
(10) Pub. No.: US 2024/0424713 A1
(43) Pub. Date: Dec. 26, 2024

(54) PROCESS AND PLANT FOR THE CONTINUOUS PROCESSING OF FLAKES FORMED BY AT LEAST TWO DIFFERENT PLASTIC MATERIALS ATTACHED TO EACH OTHER

(71) Applicant: AMUT S.P.A., Novara (NO) (IT)

(72) Inventor: Claudio NAVONE, Novara (NO) (IT)

(21) Appl. No.: 18/693,544

(22) PCT Filed: Sep. 20, 2022
(86) PCT No.: PCT/IB2022/058859

§ 371 Date: Mar. 20, 2024

(30) Foreign Application Priority Data
Sep. 22, 2021 (EP) 21198183.2

(51) Int. Cl. B29B 17/02; B29K 67/00; B29L 31/00

(52) U.S. Cl. CPC B29B 17/02; B29B 2017/0203; B29B 2017/0217; B29B 2017/0289; B29K 2023/06; B29K 2067/003; B29L 2031/712

(57) ABSTRACT

A process and plant are described for the continuous processing of flakes formed by at least two layers of different plastic materials attached to each other by gluing or by a hot-rolling process. The process provides for feeding the flakes to a delamination reactor (10) containing a first aqueous solution of chemicals kept at an adjustable temperature, keeping the flakes under stirring to separate from each other the layers of flakes of the at least two different plastic materials. The mixture of layers of flakes is then fed to an intensive washing equipment (20) containing a second aqueous solution of chemicals kept at an adjustable temperature. Once the washing has been carried out, the layers of flakes are drawn from the intensive washing equipment (20) to be transferred to other treatment stations downstream of the plant. A control unit (100) allows regulation of various process parameters.

### FIELD OF THE INVENTION

The present invention concerns a process and a plant for the continuous processing of flakes formed by at least two different plastic materials attached to each other by gluing or by hot-rolling processes. In particular, the present invention relates to the treatment of flakes comprising, e.g., polyethylene terephthalate, hereinafter also referred to as PET, which is commonly known in the art, and polyethylene, hereinafter also referred to as PE, which is commonly known in the art, the layers of which are attached by gluing or by a hot-rolling process.

These flakes are generally found in the recovery treatments of PET and/or PE coming from the grinding of bowls and trays for packaging and storing food products. In fact, the bowls and trays are made of PET, e.g. by thermoforming, and are sealed by means of single- or multi-layer PE sheets. However, it is not possible to use the common heat-sealing techniques to attach the PE sheets to the edges of the PET bowls (or trays). It is therefore necessary to make the PE sealing sheets adhere firmly to the edges of the PET bowls (or trays) by gluing or by a hot-rolling process.

### PRIOR ART

In the sector of recovery/recycling of plastic materials, the processing of flakes consisting of a single plastic material, e.g. PET flakes coming from bottles or containers in general, is known. Various techniques have been adopted to treat PET bottles or containers prior to flaking, in order to eliminate e.g. paper labels, heat-shrink sheaths made of different plastic materials or other pollutants adhering to bottles and/or containers.

Some examples of these types of treatment of bottles and containers can be found in EP 0237127 A1 in the name of Stamicarbon or in WO 99/55508 A1 in the name of the Applicant.

However, these types of treatment applied directly to the containers prior to flaking are not very effective for carrying out the treatment of PET bowls and trays, to which a PE sheet adheres firmly, to separate the different plastic materials.

### SUMMARY OF THE INVENTION

That being said, the technical task of the present invention is to propose a process and a plant for the continuous processing of flakes formed by at least two different plastic materials attached to each other by gluing or by a hot-rolling process.

In particular, it is an object of the present invention to provide a process and a plant which allow to efficiently separate the layers of different plastic materials by operating on the flakes rather than on the containers.

Another object of the present invention is to provide a process and a plant which also allow to carry out the washing of the layers of different plastic materials once separated, by further eliminating any possible glues adhering to these layers.

A further object of the present invention is to provide a process and a plant which allow to subsequently recover, separately, the layers of both plastic materials previously attached to each other by gluing or by a hot-rolling process.

These and other objects are achieved by the present invention which concerns a process according to claim 1. Further peculiar characteristics of the present invention are set forth in the respective dependent claims.

A process for the continuous processing of flakes formed by at least two layers of different plastic materials firmly attached to each other, comprises the steps of:
a) feeding the flakes with a constant flow rate to a delamination reactor containing a first aqueous solution of chemicals kept at an adjustable temperature;
b) keeping the flakes in the first aqueous solution under stirring for an adjustable time, in such a way as to separate from each other the layers of flakes of the at least two different plastic materials, by keeping them in the first aqueous solution;
c) drawing in a controlled a mixture of layers of flakes of the at least two different plastic materials, together with part of the first aqueous solution, from the delamination reactor;
d) feeding the mixture of layers of flakes of the at least two different plastic materials separated from each other to an intensive washing equipment containing a second aqueous solution of chemicals kept at an adjustable temperature,
e) keeping the mixture of the layers of flakes of the at least two different plastic materials in the second aqueous solution under stirring for an adjustable time, in such a way as to exert a frictional action between the layers of flakes of the at least two different plastic materials and wash the layers of flakes;
f) drawing in a controlled manner the mixture of layers of flakes of the at least two different plastic materials from the intensive washing equipment, together with part of the second aqueous solution, from the intensive washing equipment.

According to an embodiment of the process of the invention, the following are continuously controlled:
the concentration of the flakes in the delamination reactor, by regulating the quantity of flakes drawn from the delamination reactor;
the residence time of the flakes in the delamination reactor;
the concentration of the layers of flakes of the at least two different plastic materials in the intensive washing equipment, by regulating the quantity of the mixture of layers of flakes which are drawn from the intensive washing equipment; and
the residence time of the mixture of layers of flakes of the at least two different plastic materials in the intensive washing equipment.

Thanks to the process according to the present invention, the layers of flakes of the two different types of materials, e.g. PET layers attached to PE layers, are efficiently separated and the layers of each of the two materials are then recovered separately downstream, e.g. by flotation in settling tanks in which the PET layers sink while the PE layers float.

In addition, the temperature of the first aqueous solution in the delamination reactor and the temperature of the second aqueous solution in the intensive washing equipment are controlled.

A further control is carried out on the concentration of chemicals of the first aqueous solution contained in the delamination reactor and on the concentration of chemicals of the second aqueous solution contained in the intensive washing equipment.

The intensity of stirring of the flakes in the first aqueous solution contained in the delamination reactor is also regulated, e.g. depending on the concentration of the flakes in the delamination reactor.

Once the layers have been separated, the mixture of the layers of flakes of the at least two different plastic materials is drawn from the delamination reactor together with part of the first aqueous solution and the separation of the layers of flakes from the part of first aqueous solution drawn with the mixture of layers of flakes is provided.

The part of the first aqueous solution, which has been drawn with the mixture of layers of flakes of the at least two different plastic materials, is then filtered and reintroduced into the delamination reactor, by possibly correcting the concentration of the chemicals before this part of the first aqueous solution is reintroduced into the delamination reactor.

Similarly, the drawing of the mixture of layers of flakes of the at least two different plastic materials from the intensive washing equipment provides for the separation of the part of the second aqueous solution drawn with the mixture of layers of flakes. The part of second aqueous solution drawn with the mixture of layers of flakes of the at least two different plastic materials is then filtered and reintroduced into the intensive washing equipment. Even in this case, it is possible to correct the concentration of the chemicals in the second aqueous solution before it is reintroduced into the intensive washing equipment.

The chemicals used in the first aqueous solution may comprise, e.g., soda and/or detergents. The second aqueous solution may also comprise chemicals, e.g. detergents or the like.

The invention further relates to a plant for the continuous processing of flakes formed by at least two layers of different plastic materials firmly attached to each other by gluing or by hot-rolling processes.

A plant of this type generally comprises:
at least one delamination reactor containing a first aqueous solution of chemicals and equipped with at least one stirrer for separating from each other the layers of flakes of the at least two different plastic materials;
at least one first screw conveyor for feeding the flakes to the delamination reactor, by separating them from the water coming from the treatment stations placed upstream of the plant;
first extraction means for drawing the mixture of layers of flakes of the at least two different plastic materials, together with part of the first aqueous solution, from the delamination reactor;
at least one intensive washing equipment containing a second aqueous solution of chemicals and equipped with at least one stirrer to exert a frictional action between the layers of flakes of the at least two different plastic materials and wash the layers of flakes;
at least one second screw conveyor for feeding the mixture of layers of flakes of the at least two different plastic materials separated from each other to the intensive washing equipment, by separating the mixture of layers of flakes from the first aqueous solution coming from the delamination reactor; and
second extraction means for extracting the layers of flakes of the at least two different plastic materials from the intensive washing equipment.

A plant according to an embodiment of the present invention comprises at least one control unit for continuously regulating at least the following parameters:
the concentration of the flakes in the delamination reactor, by regulating the quantity of flakes drawn from the delamination reactor;
the residence time of the flakes in the delamination reactor;
the concentration of the layers of flakes in the intensive washing equipment, by regulating the quantity of the mixture of the layers of flakes which are drawn from the intensive washing equipment; and
the residence time of the mixture of layers of flakes in the intensive washing equipment.

Various filters are installed in the plant to eliminate any possible contaminants dispersed in the water and/or in the aqueous solutions used in the delamination reactor and in the intensive washing equipment in order to be able to reuse these fluids in the various steps of the process. In particular, at least one filtering device is installed to filter the water coming from the stations for the treatment of plastic materials, which are placed upstream of the plant in order to reintroduce it into those treatment stations; at least one filtering device to filter the part of the first aqueous solution drawn with the mixture of layers of flakes and reintroduce it into the delamination reactor; and at least one filtering device to filter the second aqueous solution drawn with the mixture of layers of flakes and reintroduce it into the intensive washing equipment.

### BRIEF DESCRIPTION OF THE DRAWINGS

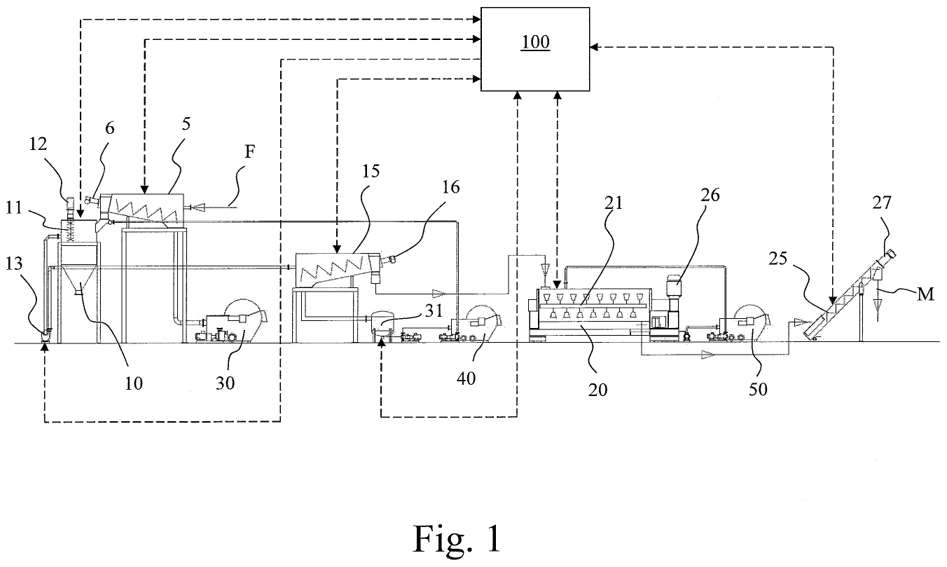

Further characteristics and advantages of the present invention will become clearer from the following description, made only by way of non-limiting example, with reference to the plant diagram depicted in FIG. 1.

### EMBODIMENTS OF THE INVENTION

FIG. 1 depicts the diagram of a plant for carrying out the process according to the present invention. The whole process is controlled by a control unit 100 which supervises the various operating regulations of the plant for carrying out the process of the present invention.

The arrow F denotes the flakes which are fed to a delamination reactor 10 through a screw conveyor 5 for separating the flakes F from the water, or otherwise from a fluid adhering thereto, which comes from the upstream stages. As an example, the upstream stages may comprise a water mill for grinding bowls and trays comprising a PET container and a single- or multi-layer PE sheet applied by gluing or by hot-rolling. The electric motor 6 of the feeding screw conveyor 5 is controlled by the control unit 100 to ensure feeding of the flakes F at a possibly constant flow rate.

The water separated from the flakes F in the screw conveyor 5 is sent to a filtering device 30 to be filtered from any possible residues and then be reintroduced into the treatment stations placed upstream of the plant.

The delamination reactor 10 contains a first aqueous solution of chemicals kept at a temperature adjustable by the control unit 100. A stirrer 11 is installed in the delamination reactor 10 and moved by an electric motor 12 to keep the flakes F in the first aqueous solution under stirring. The control unit 100 also regulates the intensity of stirring, e.g., depending on the concentration of the flakes in the delamination reactor, the temperature and the residence time of the flakes F in the delamination reactor 10. The residence time can be regulated by acting, e.g., on first extraction means 13 which draw the mixture of layers of flakes of the at least two different plastic materials, now separated, together with part of the first aqueous solution. This allows to keep the flakes F in the delamination reactor 10 for the time sufficient to separate the reciprocally adhering layers in the flakes comprising the two different plastic materials. The first extraction means 13 can consist of, e.g., a pump, as depicted in FIG. 1, or alternatively a screw conveyor.

The first extraction means 13 then draw from the delamination reactor 10 a mixture of layers of flakes reciprocally separated, together with part of the first aqueous solution, to be fed to an intensive washing equipment 20 through a screw conveyor 15 for separating the layers of flakes from the first aqueous solution. The screw conveyor 15 is actuated by an electric motor 16 controlled by the control unit 100.

The first aqueous solution is collected in a tank 31, in which the concentration of the chemicals is possibly corrected, e.g. by detecting the pH of the first aqueous solution through the control unit 100 and then, before being reintroduced into the delamination reactor 10, it is filtered in a filtering device 40 to remove any possible contaminating residues. These treatment steps allow to remove at least part of the possible glue between the various layers of flakes of the two different plastic materials.

The intensive washing equipment 20 contains a second aqueous solution of chemicals, which is kept at an adjustable temperature. In the intensive washing equipment 20, the mixture of layers of flakes is subjected to vigorous stirring which is imparted by a stirrer 21. The latter is rotated by a motor 26 controlled by the control unit 100.

The stirring of the mixture of layers of flakes in the second aqueous solution causes the continuous frictional action between the layers of flakes and thus allows to achieve a complete washing of the layers, by especially removing any possible residual fractions of glue therefrom. Even in this case, the residence time of the mixture of layers of flakes inside the intensive washing equipment 20 is controlled and the temperature of the second aqueous solution is controlled.

The residence time is determined, e.g., by the actuation of the extraction means 25, which draw the mixture of layers of flakes in a controlled manner. The control unit 100 then operates on the motor 27 of the extraction means 25 to draw the mixture of layers of flakes only after a determined residence time in the intensive washing equipment 20.

The second extraction means 25 can consist of, e.g., a screw conveyor, as depicted schematically in FIG. 1, which allows to separate the exiting mixture of layers of flakes (arrow M) from the second aqueous solution contained in the intensive washing equipment 20. Alternatively, the second extraction means 25 can consist of a pump, by then separating the mixture of layers of flakes from the second aqueous solution. The second aqueous solution is then filtered in a filtering device 50 to remove any possible contaminating residues before being reintroduced into the intensive washing equipment 20.

In addition to the regulations mentioned so far with reference to FIG. 1, the control unit 100 is arranged to detect and regulate further process parameters, such as e.g. the temperature and concentration of chemicals of the first aqueous solution contained in the delamination reactor 10, the temperature and concentration of chemicals of the second aqueous solution in the intensive washing equipment 20.

Furthermore, it is possible to correct the concentration of the chemicals also in the second aqueous solution before it is reintroduced into the intensive washing equipment. This can be done, e.g., by detecting the pH of the second aqueous solution and by introducing, if necessary, any possible additives and/or detergents before reintroducing it into the intensive washing equipment 20.

1. A process for the continuous processing of flakes formed by at least two layers of different plastic materials attached to each other by gluing or by a hot-rolling process, the process comprising the steps of:
a) feeding said flakes with constant flow rate to a delamination reactor (10) containing a first aqueous solution of chemicals kept at an adjustable temperature;
b) keeping said flakes in said first aqueous solution under stirring for an adjustable time, in such a way as to separate from each other the layers of flakes of said at least two different plastic materials, by keeping them in said first aqueous solution;
c) drawing in a controlled manner the mixture of layers of flakes of said at least two different plastic materials, together with part of said first aqueous solution, from said delamination reactor (10);
d) feeding the mixture of layers of flakes of said at least two different plastic materials separated from each other to an intensive washing equipment (20) containing a second aqueous solution of chemicals kept at an adjustable temperature,
e) keeping said layers of flakes of said at least two different plastic materials in said second aqueous solution under stirring for an adjustable time, in such a way as to exert a frictional action between the layers of flakes of said at least two different plastic materials and wash said layers of flakes;
f) drawing the mixture of layers of flakes of said at least two different plastic materials in a controlled manner from said intensive washing equipment (20), together with part of said second aqueous solution,
characterised by continuously controlling:
the concentration of said flakes in said delamination reactor (10), by regulating the quantity of flakes drawn from said delamination reactor (10);
the temperature of said first aqueous solution in said delamination reactor (10);
the residence time of said flakes in said delamination reactor (10);
the concentration of said layers of flakes of said at least two different plastic materials in said intensive washing equipment (20), by regulating the quantity of mixture of said layers of flakes drawn from said intensive washing equipment (20);
the temperature of said second aqueous solution in said intensive washing equipment (20); and
the residence time of said layers of flakes of said at least two different plastic materials in said intensive washing equipment (20).

2. The process according to claim 1, wherein the concentration of chemicals of said first aqueous solution in said delamination reactor (10) and the concentration of chemicals of said second aqueous solution in said intensive washing equipment (20) are controlled.

3. The process according to claim 1, wherein the intensity of stirring of said flakes in said first aqueous solution contained in said delamination reactor (10) is regulated.

4. The process according to claim 1, wherein said step c) of drawing the mixture of layers of flakes of said at least two different plastic materials from said delamination reactor (10) provides for separating the part of said first aqueous solution drawn with the mixture of said layers of flakes.

5. The process according to claim 4, wherein the part of said first aqueous solution drawn with the mixture of layers of flakes of said at least two different plastic materials is filtered and reintroduced into said delamination reactor (10).

6. The process according to claim 1, wherein said step f) of drawing the mixture of layers of flakes of said at least two different plastic materials from said intensive washing equipment (20) provides for separating the part of said second aqueous solution drawn with the mixture of said layers of flakes.

7. The process according to claim 6, wherein the part of said second aqueous solution drawn with the mixture of layers of flakes of said at least two different plastic materials is filtered and reintroduced into said intensive washing equipment (20).

8. The process according to claim 1, wherein said first aqueous solution comprises soda and detergents.

9. The process according to claim 1, wherein a first of said at least two different plastic materials consists of polyethylene terephthalate, or PET, and wherein a second of said at least two different plastic materials consists of single- or multi-layer polyethylene, or PE.

10. A plant for the continuous processing of flakes formed by at least two layers of different plastic materials attached to each other by gluing or by a hot-rolling process, the plant comprising:
at least one delamination reactor (10) containing a first aqueous solution of chemicals and equipped with at least one stirrer for separating from each other the layers of flakes of said at least two different plastic materials;
at least one first screw conveyor (5) for feeding said flakes to said delamination reactor (10), by separating them from the water coming from the treatment stations placed upstream of the plant;
first extraction means (13) for drawing the mixture of layers of flakes of said at least two different plastic materials, together with part of said first aqueous solution, from said delamination reactor (10);
at least one intensive washing equipment (20) containing a second aqueous solution of chemicals and equipped with at least one stirrer for exerting a frictional action between the layers of flakes of said at least two different plastic materials, and washing said layers of flakes;
at least one second screw conveyor (15) for feeding the mixture of layers of flakes of said at least two different plastic materials separated from each other to said intensive washing equipment (20), by separating them from said first aqueous solution coming from said delamination reactor (10); and
second extraction means (25) for extracting, from said intensive washing equipment (20) for washing said layers of flakes, said at least two different plastic materials,
characterised by comprising at least one control unit for continuously regulating at least the following parameters:
the concentration of said flakes in said delamination reactor (10), by regulating the quantity of flakes drawn from said delamination reactor (10);
the temperature of said first aqueous solution in said delamination reactor (10);
the residence time of said flakes in said delamination reactor (10);
the concentration of said layers of flakes in said intensive washing equipment (20), by regulating the quantity of mixture of layers of flakes drawn from said intensive washing equipment (20);
the temperature of said second aqueous solution in said intensive washing equipment (20); and
the residence time of said layers of flakes in said intensive washing equipment (20).

11. The plant according to claim 10, wherein the following are installed: at least one filtering device (30) for filtering the water coming from the stations for the treatment of plastic materials, which are placed upstream of the plant and reintroducing it into said treatment stations; at least one filtering device (40) for filtering the part of said first aqueous solution drawn with the mixture of said layers of flakes and reintroducing it into said delamination reactor (10); and at least one filtering device (50) for filtering said second aqueous solution drawn with the mixture of said layers of flakes and reintroducing it into said intensive washing equipment (20).
